(19) United States
(12) Patent Application Publication
(10) Pub. No.: US 2026/0080063 A1
(43) Pub. Date: Mar. 19, 2026

(54) FIRMWARE UPDATING METHOD AND ELECTRONIC APPARATUS

(71) Applicant: KYOCERA Document Solutions Inc., Osaka (JP)

(72) Inventors: Hiroshi Furutani, Osaka (JP); Akihiko Ikazaki, Osaka (JP); Yukihiro Shibata, Osaka (JP); Tetsuya Matsusaka, Osaka (JP); Yohei Yamada, Osaka (JP); Koto Takasu, Osaka (JP)

(21) Appl. No.: 19/326,408

(22) Filed: Sep. 11, 2025

(30) Foreign Application Priority Data
Sep. 17, 2024 (JP) 2024-159755

(51) Int. Cl. G06F 21/57

(52) U.S. Cl. CPC G06F 21/572

(57) ABSTRACT

A firmware updating method includes the steps of: updating the firmware to an intermediate firmware; and performing a firmware separation function in the intermediate firmware, and by the firmware separation function (a) determining a firmware for this electronic apparatus, (b) determining whether a specific identifier is included in the determined firmware or not, and (c) if the specific identifier is included in the determined firmware, updating the firmware included in the electronic apparatus with the determined firmware, and if the specific identifier is not included in the determined firmware, prohibiting updating the firmware included in the electronic apparatus with the determined firmware.

### CROSS-REFERENCE TO RELATED APPLICATIONS

This application relates to and claims priority rights from Japanese Patent Application No. 2024-159755, filed on September 17, 2024, the entire disclosures of which are hereby incorporated by reference herein.

### BACKGROUND

### 1. Field of the Present Disclosure

The present disclosure relates to a firmware updating method and an electronic apparatus.

### 2. Description of the Related Art

An information processing apparatus determines a firmware to be updated and a firmware not to be updated among firmwares in a firmware list on the basis of version information of the firmwares in the firmware list.

In an electronic apparatus, whether a firmware can be updated (i.e. can operate normally) or not depends on an environment such as hardware configuration. In other words, due to a type of an electronic apparatus, some firmwares can not be applied to an electronic apparatus if the electronic apparatus is not in a specific environment, even though the firmwares can be applied to an electronic apparatus of the same type in the specific environment.

Therefore, in the aforementioned information processing apparatus, even though a firmware can not be applied due to an environment such as hardware configuration, the firmware is determined as a firmware to be updated on the basis of version information as mentioned and applied, and consequently, after updating, the firmware may not operate normally.

### SUMMARY

A firmware updating method for a firmware included in an electronic apparatus according to an aspect of the present disclosure includes the steps of: updating the firmware to an intermediate firmware; and performing a firmware separation function in the intermediate firmware, and by the firmware separation function (a) determining a firmware for this electronic apparatus, (b) determining whether a specific identifier is included in the determined firmware or not, and (c) if the specific identifier is included in the determined firmware, updating the firmware included in the electronic apparatus with the determined firmware, and if the specific identifier is not included in the determined firmware, prohibiting updating the firmware included in the electronic apparatus with the determined firmware.

An electronic apparatus according to an aspect of the present disclosure includes a storage device configured to store a firmware included in the electronic apparatus, and a processor. Further, the processor (a) updates the firmware to an intermediate firmware; and (b) performs a firmware separation function in the intermediate firmware, and by the firmware separation function (b1) determines a firmware for this electronic apparatus, (b2) determines whether a specific identifier is included in the determined firmware or not, and (b3) if the specific identifier is included in the determined firmware, updates the firmware included in the electronic apparatus with the determined firmware, and if the specific identifier is not included in the determined firmware, prohibits updating the firmware included in the electronic apparatus with the determined firmware.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of a system that includes an image forming apparatus according to an embodiment of the present disclosure;

FIG. 2 shows a block diagram that indicates a configuration of the image forming apparatus 1 according to an embodiment of the present disclosure;

FIG. 3 shows a block diagram that explains a configuration of the image forming apparatus 1 after a firmware 21 is updated with an intermediate firmware 21a;

FIG. 4 shows a block diagram that explains a configuration of the image forming apparatus 1 after the intermediate firmware 21a is updated with a specific firmware 21b; and

FIG. 5 shows a flowchart that explains firmware updating on the basis of an intermediate firmware.

### DETAILED DESCRIPTION

Hereinafter, an embodiment according to an aspect of the present disclosure will be explained with reference to drawings.

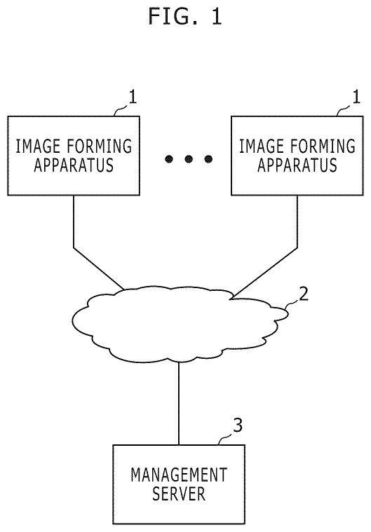

FIG. 1 shows a block diagram that indicates a configuration of a system that includes an image forming apparatus according to an embodiment of the present disclosure. In the system shown in FIG. 1, plural image forming apparatuses 1 are connected to a network 2 such as local area network. The image forming apparatus 1 is an apparatus such as multi function peripheral and is a sort of an electronic apparatus. The plural image forming apparatuses 1 may include different built-in hardware environments from each other. For example, in one of the image forming apparatuses 1, a specific hardware mentioned below is installed, but in another one of the image forming apparatuses 1, such a specific hardware is not installed.

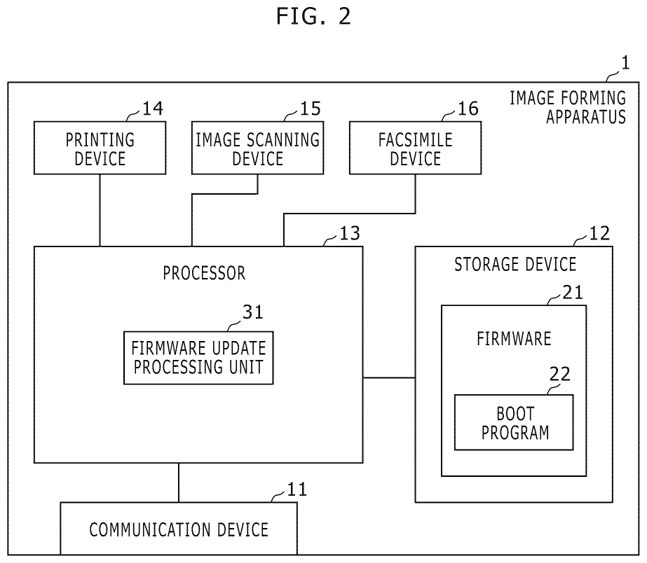

FIG. 2 shows a block diagram that indicates a configuration of the image forming apparatus 1 according to an embodiment of the present disclosure. As shown in FIG. 2, each of the image forming apparatuses 1 shown in FIG. 1 includes a communication device 11, a storage device 12, a processor 13, a printing device 14, an image scanning device 15, a facsimile device 16 and the like.

The communication device 11 is a device such as network interface that is connected to the network 2 and performs data communication in accordance with a predetermined protocol.

The storage device 12 is a non-volatile and rewritable storage device, and stores a firmware 21 and a boot program 22 that are included in this image forming apparatus 1. For example, the firmware 21 includes not only a controller program and sorts of data but the boot program 22. The boot program 22 is a program executed immediately when this image forming apparatus starts.

The processor 13 is a computer which includes a CPU (Central Processing Unit), a ROM (Read Only Memory), and a RAM (Random Access Memory), loads a program (the firmware 21 and the like) from the ROM, the storage device 12 or the like to the RAM, and executes the program with the CPU to act as various processing units.

In the processor 13, a controller program in the firmware 21 is executed, and thereby the processor 13 acts as a controller that includes a firmware update processing unit 31. The controller performs sorts of processes and controls internal devices such as the printing device 14, the image scanning device 15, and the facsimile device 16.

The printing device 14 prints an image based on print data received from an external device, an image scanned by the image scanning device 15, an image generated by the facsimile device 16, or the like. The image scanning device 15 optically scans a document image of a document and generates document image data of the document image. The facsimile device 16 generates and transmits a facsimile signal based on an image based on print data received from an external device, an image scanned by the image scanning device 15 or the like, and receives a facsimile signal from an external device and generates an image from the received facsimile signal.

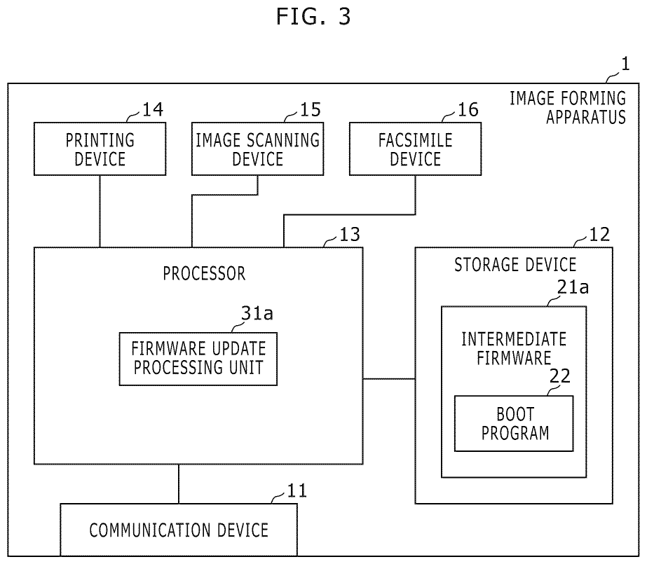

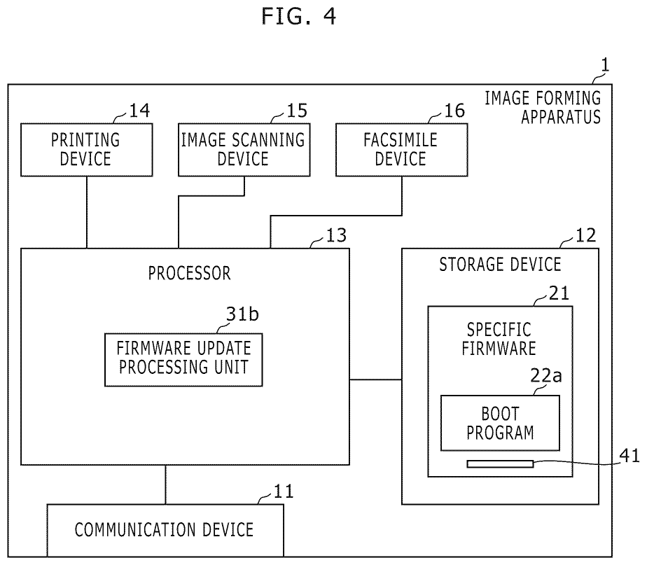

FIG. 3 shows a block diagram that explains a configuration of the image forming apparatus 1 after the firmware 21 is updated with an intermediate firmware 21a. FIG. 4 shows a block diagram that explains a configuration of the image forming apparatus 1 after the intermediate firmware 21a is updated with a specific firmware 21b.

The processor 13 in the image forming apparatus 1 that has a specific environment (e.g. includes a specific hardware) (a) updates the firmware 21 with the intermediate firmware 21a, (b) performs the firmware separation function in the intermediate firmware 21a, and by the firmware separation function, (b1) determines a firmware for this image forming apparatus 1 on the basis of a machine type of the image forming apparatus 1 and/or version information of the firmware, (b2) determines whether the determined firmware includes a specific identifier 41 or not, (b3) if the determined firmware includes the specific identifier 41, updates a firmware included in this image forming apparatus 1 (here, the intermediate firmware 21a) with the determined firmware (specific firmware 21b), and contrarily if the determined firmware does not include the specific identifier 41, prohibits updating a firmware included in this image forming apparatus 1 (here, the intermediate firmware 21a) with the determined firmware.

Specifically, the firmware update processing unit 31 based on the original firmware 21 updates the firmware 21 stored in the storage device 12 with the intermediate firmware 21a as shown in FIG. 3, for example. It should be noted that the firmware 21 does not have the firmware separation function.

Subsequently, the firmware update processing unit 31a based on the intermediate firmware 21a updates the intermediate firmware 21a stored in the storage device 12 with the specific firmware 21b that includes the specific identifier 41 as shown in FIG. 4, for example.

The firmware update processing unit 31b based on the specific firmware 21b updates the specific firmware 21b stored in the storage device 12 with another firmware that includes the specific identifier 41. Therefore, the specific firmware 21b is not updated with another firmware that does not include such a specific identifier 41.

The firmware update processing unit 31, 31a or 31b may automatically download a firmware for update (the intermediate firmware 21a, the specific firmware 21b or the like) from the management server 3, and may automatically update the firmware 21 stored in the storage device 12 with the downloaded firmware for update, or may manually update it on the basis of an operation of a user, a service person or the like.

The firmware that includes the specific identifier 41 (the specific firmware 21b) performs a process that uses the specific hardware included in the image forming apparatus 1, and a firmware that does not include the specific identifier 41 does not perform a process that uses the specific hardware included in the image forming apparatus 1.

For example, the specific hardware is a trusted platform module (TPM), and the specific firmware 21b includes a boot program 22a, and the boot program 22a is a program to perform secure boot using the TPM. Further, the firmware that includes the specific identifier 41 (the specific firmware 21b) has the firmware separation function. It should be noted that the boot program 22 does not perform secure boot.

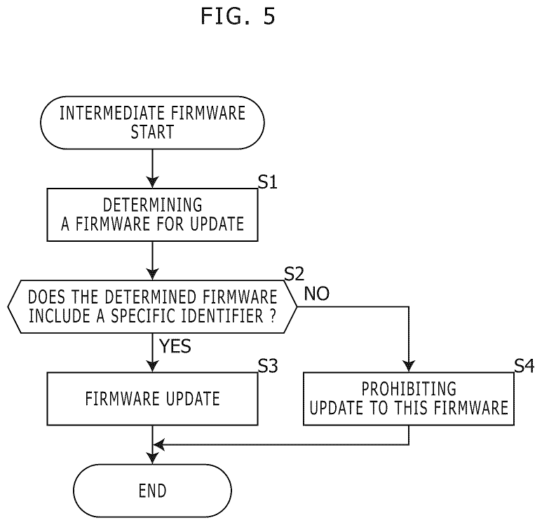

The following part explains a behavior of the aforementioned image forming apparatus 1. FIG. 5 shows a flowchart that explains firmware updating on the basis of the intermediate firmware 21a.

A firmware 21 originally included in the image forming apparatus 1 does not have the firmware separation function. If the specific hardware has been installed in the image forming apparatus 1, then firstly the firmware 21 is updated with the intermediate firmware 21a that has the firmware separation function. For example, when the specific hardware is installed, the firmware 21 is updated with the intermediate firmware 21a.

Afterward, the firmware separation function in the intermediate firmware 21a is performed. By the firmware separation function, (a) a firmware for this image forming apparatus 1 (firmware for update) is determined (in Step S1), (b) it is determined whether the specific identifier 41 is included in the determined firmware or not (in Step S1).

If the specific identifier 41 is included in the determined firmware, then a firmware included in this image forming apparatus 1 is updated with the determined firmware (in Step S3).

Contrarily, if the specific identifier 41 is not included in the determined firmware, then it is prohibited that a firmware included in this image forming apparatus 1 is updated with the determined firmware (in Step S4).

Consequently, even if there are image forming apparatuses 1 of a single type, the specific firmware 21b is not installed in the image forming apparatus 1 in which the specific hardware is not installed.

As mentioned, in the aforementioned embodiment, the storage device 12 stores a firmware 21 included in the image forming apparatus 1. The processor 13 (a) updates the firmware 21 to an intermediate firmware 21a; and (b) performs a firmware separation function in the intermediate firmware, and by the firmware separation function (b1) determines a firmware for this image forming apparatus 1, (b2) determines whether a specific identifier 41 is included in the determined firmware or not, and (b3) if the specific identifier is included in the determined firmware (i.e. in case of a specific firmware 21b), updates the firmware included in this image forming apparatus 1 with the determined firmware, and if the specific identifier 41 is not included in the determined firmware, prohibits updating the firmware included in this image forming apparatus 1 with the determined firmware.

Consequently, a proper firmware is applied correspondingly to an environment in the image forming apparatus 1, for example, correspondingly to whether a specific hardware is installed or not.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. A firmware updating method for a firmware included in an electronic apparatus, comprising the steps of:
updating the firmware to an intermediate firmware; and
performing a firmware separation function in the intermediate firmware, and by the firmware separation function (a) determining a firmware for this electronic apparatus, (b) determining whether a specific identifier is included in the determined firmware or not, and (c) if the specific identifier is included in the determined firmware, updating the firmware included in the electronic apparatus with the determined firmware, and if the specific identifier is not included in the determined firmware, prohibiting updating the firmware included in the electronic apparatus with the determined firmware.

2. An electronic apparatus, comprising:
a storage device configured to store a firmware included in the electronic apparatus; and
a processor;
wherein the processor (a) updates the firmware to an intermediate firmware; and (b) performs a firmware separation function in the intermediate firmware, and by the firmware separation function (b1) determines a firmware for this electronic apparatus, (b2) determines whether a specific identifier is included in the determined firmware or not, and (b3) if the specific identifier is included in the determined firmware, updates the firmware included in the electronic apparatus with the determined firmware, and if the specific identifier is not included in the determined firmware, prohibits updating the firmware included in the electronic apparatus with the determined firmware.

3. The electronic apparatus according to claim 2, wherein the firmware in which the specific identifier is included performs a process that uses a specific hardware; and
the firmware in which the specific identifier is not included does not perform the process that uses the specific hardware.

4. The electronic apparatus according to claim 3, wherein the specific hardware is a trusted platform module.

5. The electronic apparatus according to claim 2, wherein the firmware in which the specific identifier is included has the firmware separation function.
